(19) United States
(12) Patent Application Publication
(10) Pub. No.: US 2023/0134487 A1
(43) Pub. Date: May 4, 2023

(54) ELECTRIC MOTOR CONTROL DEVICE AND ELECTRIC MOTOR DRIVE SYSTEM

(71) Applicant: Mitsubishi Electric Corporation, Tokyo (JP)

(72) Inventor: Hayato TANABE, Tokyo (JP)

(73) Assignee: Mitsubishi Electric Corporation, Tokyo (JP)

(21) Appl. No.: 17/841,291

(22) Filed: Jun. 15, 2022

(30) Foreign Application Priority Data
Nov. 1, 2021 (JP) 2021-178494

(51) Int. Cl. H02P 29/66

(52) U.S. Cl. CPC H02P 29/662; H02P 2207/05

(57) ABSTRACT

An electric motor control device includes an inverter circuit, which has a power conversion circuit configured of six switching elements, and a switching control circuit that controls the switching elements in such a way as to be turned on or off, wherein, when it is determined that the inverter circuit is in an abnormal state, an execution of a three-phase short-circuiting process, whereby all upper side switching elements or all lower side switching elements are turned on, or a six-switch opening process, whereby all the switching elements are turned off, is selected based on a temperature of at least one permanent magnet of an electric motor, in accordance with an operating state of the electric motor.

### BACKGROUND OF THE INVENTION

### Technical Field

The present application relates to the field of an electric motor control device and an electric motor drive system.

### Description of the Background Art

An electric vehicle having an alternating current electric motor as a driving force source is already known, and this electric vehicle is such that a travel drive torque is generated by a powering operation of the alternating current electric motor when traveling, and a regenerative braking torque is generated by a regenerative operation of the alternating current electric motor when braking.

Herein, an electric vehicle drive system is configured of a direct current power supply formed of a rechargeable battery such as a lithium ion battery, an inverter circuit, which is formed of a capacitor and a multiple of semiconductor switches and is connected to the direct current power supply, and an alternating current electric motor connected to the inverter circuit as a load.

The inverter circuit converts direct current power of the direct current power supply into a predetermined alternating current power by turning the multiple of semiconductor switches on and off at a predetermined switching frequency, thereby adjusting torque and a rotational speed of the alternating current electric motor, which is the load. Also, depending on an operating situation, the alternating current electric motor operates as a generator, and charges the direct current power source with regenerative power generated thereby. An efficient permanent magnet three-phase synchronous electric motor is often used as an alternating current electric motor applied to an electric vehicle.

A drive system in which a three-phase synchronous electric motor is used is such that the inverter circuit is configured by each of three series circuits wherein upper side switching elements and lower side switching elements are connected in series being connected in parallel with the direct current power supply, and a midpoint of each of the three series circuits is connected to an input of one of a U-phase, a V-phase, and a W-phase of the three-phase synchronous electric motor.

Also, by the switching elements provided in each phase of the inverter circuit being turned on and off sequentially, the three-phase synchronous electric motor is driven by alternating current power whose phases differ by 120 degrees each from each other being supplied to each phase of the three-phase synchronous electric motor. Hereafter, “electric motor” indicates a three-phase synchronous electric motor, unless specifically stated otherwise. As an operating principle of the inverter circuit is generally widely known, a description will be omitted here.

In order to protect the battery, which is the direct current power supply, from overvoltage or overcurrent, switching means that separates the battery and the inverter circuit as necessary is provided in the electric vehicle drive system. A case wherein a voltage of the battery reaches a predetermined value or greater when the electric motor is carrying out a regenerative operation, a case wherein the battery voltage drops to a predetermined value or lower due to battery consumption, and a case wherein a current flowing into the battery reaches a predetermined value or greater, are cited as conditions for opening the switching means. Also, there are also cases wherein the switching means is opened due to a breakdown or a collision of the vehicle.

This kind of drive system is such that there are cases wherein the switching means is opened during a regenerative operation of the electric motor, whereby the inverter circuit is separated from the battery. Also, even in a drive system that does not have switching means, there are cases wherein the inverter circuit is separated from the battery by a power line between the battery and the inverter circuit being disconnected.

Also, in such a case, the battery cannot be charged with regenerative power flowing from the electric motor into the inverter circuit, the capacitor of the inverter circuit is charged, and there are cases wherein an overvoltage is applied to the capacitor, causing the capacitor to be damaged.

This means that when the inverter circuit is separated from the direct current power supply, there are cases wherein a six-switch opening process whereby all the inverter circuit semiconductor switches are turned off, thereby causing the inverter operation to stop, is executed. When this six-switch opening process is executed, however, power accumulated in a stator coil of the electric motor charges the capacitor via a freewheeling diode (FWD) connected in inverse parallel to the switching element, and there are cases wherein an inter-terminal voltage of the capacitor rises steeply. Increasing a capacity or increasing a withstand voltage of the capacitor as a measure against this capacitor inter-terminal voltage rise leads to an increase in size of the capacitor.

Also, increasing a withstand voltage of a constituent component of the inverter circuit is also necessary, and it becomes difficult to realize a reduction in size and a reduction in cost of the inverter circuit. This is a large problem with regards to realizing a reduction in size of an electric vehicle inverter circuit, which needs to be disposed in a limited vehicle space.

As a countermeasure, therefore, a method such that, rather than executing the six-switch opening process when the inverter circuit is separated from the direct current power supply, a three-phase short-circuiting process whereby all the upper side switching elements or all the lower side switching elements of the inverter circuit are turned on, causing the phases of the electric motor to short-circuit each other, is executed, because of which power is prevented from being regenerated to the capacitor, has been disclosed (for example, refer to Patent Literature JPA PH09-47055).

However, when causing the inverter operation to stop by turning off all the semiconductor switches of the inverter circuit when the inverter circuit is separated from the direct current power supply, there are cases wherein the inter-terminal voltage of the capacitor rises steeply, and it is necessary to increase the capacity or increase the withstand voltage of the capacitor as a measure against this, as heretofore described. This results in an increase in size of the capacitor, and is a drawback with regards to realizing a reduction in size and a reduction in cost of the inverter circuit.

Also, an electrical system of the electric vehicle of Patent Literature JPA PH09-47055 is such that when a three-phase short-circuiting of the electric motor phases is carried out, a rise in the capacitor inter-terminal voltage can be restricted, but a transient current is generated by the power accumulated in the stator coil of the electric motor. A transient current generated in this way flows in a direction that causes demagnetization of the permanent magnet of the electric motor, because of which there are cases wherein an irreversible demagnetization occurs in the permanent magnet of the electric motor. When an irreversible demagnetization occurs, there is a problem in that the necessary torque can no longer be obtained from the electric motor, as a result of which acceleration and deceleration properties required when applying this electrical system to an electric vehicle cannot be obtained.

### SUMMARY OF THE INVENTION

The present application has been made to solve the above problems, and an object of the present application is to provide, in a small size and at a low cost, an electric motor control device such that, when a failure occurs in an inverter circuit or an electric motor, a rise in an inter-terminal voltage of a capacitor and a rise in a phase current flowing into each phase of the electric motor are restricted, and an occurrence of a failure in the inverter circuit or the electric motor is restricted.

An electric motor control device disclosed in the present application includes an inverter circuit that has a power conversion circuit that supplies alternating current drive power to an electric motor having permanent magnets, and in which three phases of arms are each configured of a series circuit of an upper side switching element and a lower side switching element, and a switching control circuit that controls the switching elements of the power conversion circuit in such a way as to be turned on or off, wherein the switching control circuit has an abnormality determining circuit that determines whether or not the inverter circuit is in an abnormal state, and an abnormality countermeasure selecting circuit that, when it is determined by the abnormality determining circuit that there is an abnormal state, selects whether to execute a three-phase short-circuiting process, whereby all the upper side switching elements or all the lower side switching elements are turned on, or a six-switch opening process, whereby all the switching elements of the power conversion circuit are turned off, in accordance with an operating state of the electric motor, and the abnormality countermeasure selecting circuit acquires a temperature of at least one of the permanent magnets of the electric motor from a temperature sensor attached to the electric motor, and selects which of the three-phase short-circuiting process or the six-switch opening process to execute based on the temperature of the permanent magnet.

The electric motor control device disclosed in the present application is such that when it is determined that an abnormality in the electric motor control device is due to a power supply side abnormality, either the three-phase short-circuiting process, whereby all the upper side switching elements or all the lower side switching elements of the power conversion circuit are turned on, or the six-switch opening process, whereby all the switching elements of the power conversion circuit are turned off, is executed in accordance with an operating state of the electric motor, whereby there is an advantage in that a small-sized electric motor control device such that a rise in an inter-terminal voltage of a capacitor and a rise in a phase current flowing into each phase of the electric motor are restricted, and an occurrence of a failure in the inverter circuit or the electric motor is restricted, even when the inverter circuit is separated from the direct current power supply, can be realized at low cost.

The foregoing and other objects, features, aspects, and advantages of the present application will become more apparent from the following detailed description of the present application when taken in conjunction with the accompanying drawings.

### BRIEF DESCRIPTION OF THE DRAWINGS

FIG. 1 is a block drawing showing a configuration of an electric motor drive system in which an electric motor control device according to a first embodiment is mounted.

FIG. 2 is a block drawing showing a configuration example of a switching control circuit of the electric motor control device according to the first embodiment.

FIG. 3 is a drawing showing one example of magnetic properties of a rare-earth magnet often used as a permanent magnet of an electric motor.

FIG. 4 is a flowchart showing an operation of the electric motor control device according to the first embodiment.

FIG. 5 is a block drawing showing a configuration of an electric motor drive system in which the electric motor control device according to a second embodiment is mounted.

FIG. 6 is a flowchart showing an operation of the electric motor control device according to the second embodiment.

FIGS. 7A and 7B are drawings showing one example of a drive pattern at a time of a maximum load of an electric motor, and a maximum value of a phase current when a three-phase short-circuiting process is executed at various corresponding rotational speeds.

### DESCRIPTION OF THE PREFERRED EMBODIMENTS

Hereafter, preferred embodiments of an electric motor control device and an electric motor drive system according to the present application will be described using the drawings, but identical or corresponding portions in the drawings will be indicated by allotting identical reference signs.

Generally, an electric motor, also called simply a motor, carries out a powering operation by converting power into drive power, but can also carry out a regenerative operation by reconverting drive power into power with the same structure. Also, a power generator, also called simply a generator, carries out a regenerative operation by converting drive power into power, but can also carry out a powering operation by reconverting power into drive power with the same structure. That is, an electric motor and a power generator basically have the same structure, and both can carry out a powering operation and a regenerative operation. Consequently, a rotating electrical machine having the functions of both an electric motor and a power generator will simply be called an electric motor in the specification.

### First Embodiment

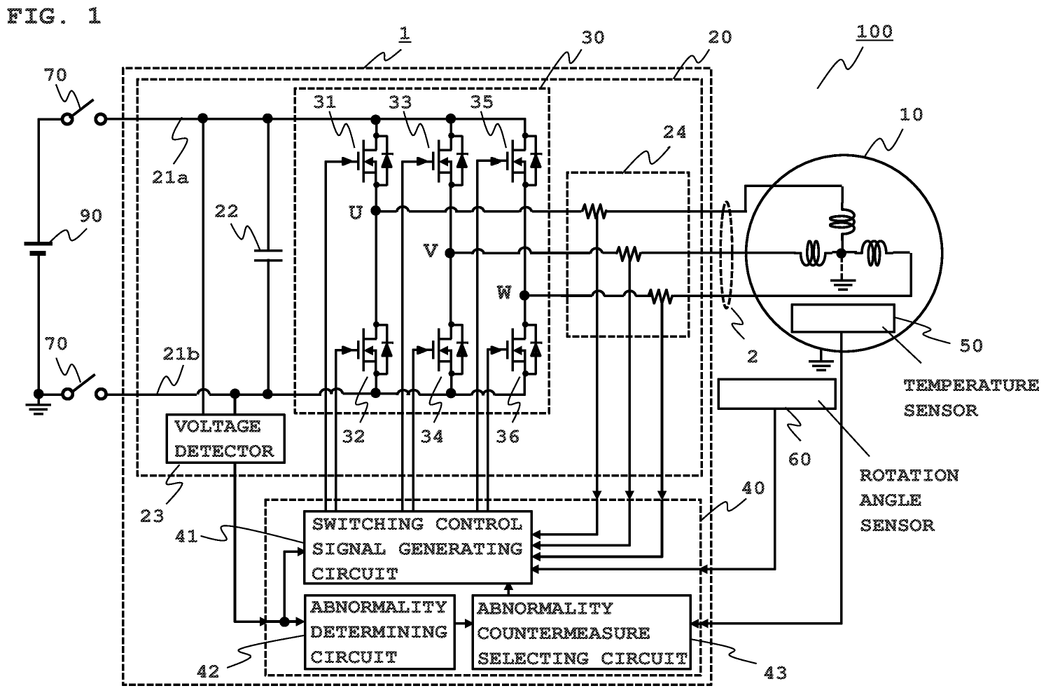

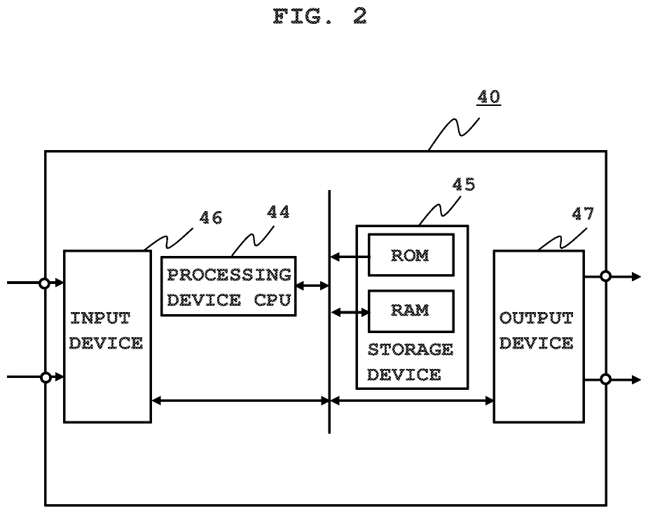

FIG. 1 is a block drawing showing a configuration of an electric motor drive system 100 in which an electric motor control device 1 according to a first embodiment is mounted. FIG. 1 includes an illustration of a direct current power source 90, a battery for example, that supplies direct current power to an inverter circuit 20 and is charged by regenerative power, and a three-phase synchronous electric motor 10 that is a control target. FIG. 2 is a block drawing showing a configuration example of a switching control circuit 40 of the electric motor control device 1 according to the first embodiment.

Firstly, a configuration and an operation of the electric motor control device 1 according to the first embodiment will be described, using FIG. 1.

The electric motor control device 1 is connected to the direct current power supply 90 by direct current buses 21a and 21b via a power switch 70, and drive power and regenerative power are received from and supplied to the direct current power supply 90. Also, the electric motor control device 1 is connected to the electric motor 10 by an alternating current bus 2, and drive power and regenerative power are supplied to and received from the electric motor 10.

Also, a temperature detecting device (temperature sensor) 50, which detects a temperature of a permanent magnet of the electric motor 10, and a rotational speed detecting device (rotation angle sensor) 60, which detects a rotational speed from a rotation angle of a rotor of the electric motor 10, are included in the electric motor 10.

The electric motor 10 is the electric motor 10 that drives a load in such a way as to rotate and can regenerate rotational energy of the load as electrical energy, and a three-phase brushless motor, such as a permanent magnet three-phase alternating current synchronous motor, or the like is used.

Also, the electric motor control device 1 is configured of the inverter circuit 20 and the switching control circuit 40.

The inverter circuit 20 is configured of a capacitor 22 connected between the direct current buses 21a and 21b on a power supply input side, a voltage detector 23 that detects a voltage of the inverter circuit 20 between the direct current buses 21a and 21b, and a multiple of switching elements 31, 32, 33, 34, 35, and 36, and includes a power conversion circuit 30, which carries out a direct current/alternating current power conversion, and a current detecting circuit 24 that detects a current flowing into the alternating current bus 2 of the electric motor 10.

The capacitor 22 has a function of restricting a ripple in a direct current bus voltage, a function of causing a power supply impedance of the inverter circuit 20 to decrease, causing an alternating current drive capacity of the inverter circuit 20 to increase, and a function of absorbing a surge voltage. Also, the voltage detector 23 divides, for example, the voltage between the direct current buses 21a and 21b into voltages that can be read by the switching control circuit 40 using a voltage dividing resistor, and outputs direct current bus voltage information to the switching control circuit 40.

The power conversion circuit 30 is configured of a generally well-known inverter circuit wherein six switching elements are connected in a full bridge. That is, as shown in FIG. 1, each of the switching element 31 and the switching element 32, the switching element 33 and the switching element 34, and the switching element 35 and the switching element 36, are connected to each other in series, whereby an arm is formed, and connected in parallel with the direct current power supply 90. Also, a midpoint of the switching element 31 and the switching element 32 is connected to an input of a U-phase of the electric motor 10, a midpoint of the switching element 33 and the switching element 34 is connected to an input of a V-phase of the electric motor 10, and a midpoint of the switching element 35 and the switching element 36 is connected to an input of a W-phase of the electric motor 10. Herein, the switching elements 31, 33, and 35 connected to a positive electrode side of the direct current power supply 90, that is, the direct current bus 21a, are called upper side switching elements, and the switching elements 32, 34, and 36 connected to a negative electrode side of the direct current power supply 90, that is, the direct current bus 21b, are called lower side switching elements.

Although the kind of metal-oxide-semiconductor field-effect transistor (MOSFET) shown in FIG. 1, for example, is generally usually used as a switching element, an insulated gate bipolar transistor (IGBT) is also used.

A freewheeling diode (FWD) is provided in parallel with each MOSFET switching element, with a direction from the negative electrode side of the direct current power supply 90 toward the positive electrode side, that is, a direction from the lower side toward the upper side, as a forward direction.

The current detecting circuit 24 detects an electric motor current flowing through the alternating current bus 2, converts the current into voltage, and outputs electric motor current information to the switching control circuit 40. A configuration wherein current is detected using a shunt resistor is shown as an example in FIG. 1. In addition to this, the current detecting circuit 24 may be a current sensor wherein a Hall element is used.

The power switch 70 controls an exchange of power between the direct current power supply 90 and the electric motor control device 1. Specifically, the power switch 70 is controlled into an opened state by an unshown host system when a voltage of the direct current power supply 90 reaches a setting value or greater when the electric motor 10 is carrying out a regenerative operation, when the voltage of the direct current power supply 90 drops to a setting value or lower due to consumption of the direct current power supply 90, when a current flowing into the direct current power supply 90 reaches a setting value or greater, or when a breakdown or a collision of a vehicle is detected. The power switch 70 may be of a configuration controlled by the switching control circuit 40.

Also, the rotation angle sensor 60 detects the rotation angle of the rotor of the electric motor 10 using a resolver, an encoder, or the like. The rotor rotation angle detected using the rotation angle sensor 60 is output to the switching control circuit 40. The rotor rotation angle is used as a rotational speed in the switching control circuit 40.

The temperature sensor 50 is configured of, for example, a thermistor, and detects the temperature of the permanent magnet of the electric motor 10. The detected permanent magnet temperature is output to the switching control circuit 40.

The switching control circuit 40 is responsible for overall control of the electric motor control device 1, is configured of a drive circuit such as a microcontroller, and has a switching control signal generating circuit 41, an abnormality determining circuit 42, and an abnormality countermeasure selecting circuit 43.

The switching control signal generating circuit 41 generates on/off control signals for controlling the multiple of switching elements 31 to 36 configuring the power conversion circuit 30 in such a way as to be turned on or off. Also, the abnormality determining circuit 42 determines whether or not there is an abnormal state on the power supply side such that regenerative power from the electric motor 10 cannot be caused to charge the direct current power supply 90.

When it is determined by the abnormality determining circuit 42 that there is an abnormal state on the power supply side, the abnormality countermeasure selecting circuit 43 selects an execution of a three-phase short-circuiting process, whereby all the upper side switching elements 31, 33, and 35 or all the lower side switching elements 32, 34, and 36 of the power conversion circuit 30 are turned on, or a six-switch opening process whereby all the switching elements 31 to 36 of the power conversion circuit 30 are turned off, in accordance with an operating state of the electric motor 10 at the time of the determination.

Specifically, the abnormality determining circuit 42 determines whether or not there is an abnormal state on the power supply side based on the direct current bus voltage information input from the voltage detector 23, and outputs a result of the determination to the abnormality countermeasure selecting circuit 43.

When the permanent magnet temperature of the electric motor 10 from the temperature sensor 50 and the power supply side abnormal state determination result from the abnormality determining circuit 42 are input, and it is determined based on these items of input information that the power supply side is in an abnormal state, the abnormality countermeasure selecting circuit 43 selects one of the three-phase short-circuiting process and the six-switch opening process, and outputs the selection to the switching control signal generating circuit 41 as an abnormality countermeasure command.

The direct current bus voltage information from the voltage detector 23, rotation angle information (a rotational speed) relating to the electric motor 10 from the rotation angle sensor 60, the electric motor current information from the current detecting circuit 24, and the abnormality countermeasure command from the abnormality countermeasure selecting circuit 43 are input, and the switching control signal generating circuit 41 generates an on/off control signal for each of the switching elements 31 to 36 of the power conversion circuit 30 in accordance with these items of input information and a torque command value and current command value of the electric motor 10 input from an exterior, and outputs the on/off control signals to the power conversion circuit 30.

The switching elements 31 to 36 are each operated in such a way as to be turned on or off by the on/off control signals from the switching control signal generating circuit 41, convert direct current power into alternating current power, supply the alternating current power to the electric motor 10, and charge the direct current power supply 90 with regenerative power generated when the electric motor 10 is in a regenerating state.

Herein, a configuration example of the switching control circuit 40 of the first embodiment will be described, using FIG. 2. As shown in FIG. 2, the switching control signal generating circuit 41, the abnormality determining circuit 42, and the abnormality countermeasure selecting circuit 43 included in the switching control circuit 40 can specifically be realized by a processing device 44, a storage device 45, an input device 46, and an output device 47.

Herein, the processing device 44 may be dedicated hardware, or may be a central processing unit (CPU (also called a microprocessor, a microcomputer, a processor, or a DSP)) that executes a program stored in the storage device 45.

When the processing device 44 is dedicated hardware, the processing device 44 may be, for example, a single circuit, a composite circuit, a programmed processor, a parallel programmed processor, an ASIC, an FPGA, or a combination of these. Functions of each of the switching control signal generating circuit 41, the abnormality determining circuit 42, and the abnormality countermeasure selecting circuit 43 may be realized individually by the processing device 44, or the functions of each circuit may be realized collectively by the processing device 44.

When the processing device 44 is a CPU, functions of each of the switching control signal generating circuit 41, the abnormality determining circuit 42, and the abnormality countermeasure selecting circuit 43 are realized by software, firmware, or a combination of software and firmware. Software and firmware are written as a processing program, and stored in the storage device 45. The processing device 44 realizes the functions of each circuit by reading and executing the processing program stored in the storage device 45.

That is, the switching control circuit 40 includes the storage device 45 for storing processing programs such that, when executed by the processing device 44, a processing step for importing a signal input from the voltage detector 23, which detects the direct current bus voltage of the inverter circuit 20, into the abnormality determining circuit 42 and the switching control signal generating circuit 41, a processing step for importing signal inputs from the current detecting circuit 24, which detects the alternating current bus current of the inverter circuit 20, and the rotation angle sensor 60, which detects the rotation angle of the electric motor 10, into the switching control signal generating circuit 41, a processing step for importing a signal input from the temperature sensor 50, which detects the temperature of the permanent magnet of the electric motor 10, into the abnormality countermeasure selecting circuit 43, a processing step of outputting the abnormality countermeasure command from the abnormality countermeasure selecting circuit 43 to the switching control signal generating circuit 41 based on the result of a determination by the abnormality determining circuit 42, and a processing step of outputting on/off signals generated by the switching control signal generating circuit 41 to the switching elements of the power conversion circuit 30 via the output device 47, are executed.

Also, these processing programs can also be said to cause a computer to execute an operating procedure or method of the switching control circuit 40. Herein, the storage device 45 may be, for example, a non-volatile or volatile semiconductor memory, such as a RAM, a ROM, a flash memory, an EPROM, or an EEPROM, a magnetic disk, a flexible disk, an optical disk, a compact disk, a mini disk, a DVD, or the like.

One portion of the functions of the switching control circuit 40 may be realized by dedicated hardware, and one portion may be realized by software or firmware. For example, the functions of the input device 46 and the output device 47 can be realized by the processing device 44, which acts as dedicated hardware, and the functions of the switching control signal generating circuit 41, the abnormality determining circuit 42, and the abnormality countermeasure selecting circuit 43 can be realized by the processing device 44 reading and executing a program stored in the storage device 45.

In this way, the processing device 44 can realize each of the aforementioned functions using hardware, software, firmware, or a combination thereof.

In addition to storing the programs for executing the aforementioned processing steps, the storage device 45 stores data acquired from a host system, data relating to a time when an abnormality occurs, and a result of processing the data.

Also, the input device 46 corresponds to one portion of the functions of the switching control signal generating circuit 41, the abnormality determining circuit 42, and the abnormality countermeasure selecting circuit 43, and acquires information output from an unshown host system. The output device 47 corresponds to one portion of the functions of the switching control signal generating circuit 41.

A characteristic of the electric motor control device 1 according to the first embodiment is that the abnormality countermeasure selecting circuit 43 is provided in the switching control circuit 40, and when it is determined that the power supply side is in an abnormal state, the abnormality countermeasure selecting circuit 43 carries out a process of selecting whether to execute the three-phase short-circuiting process or execute the six-switch opening process, based on information relating to the temperature of the permanent magnet of the electric motor 10.

According to this configuration, both of restricting a rise in an inter-terminal voltage of the capacitor 22 and restricting an occurrence of an irreversible demagnetization accompanying a rise in a phase current of the electric motor 10 can be achieved, even when the inverter circuit 20 is separated from the direct current power supply 90. Hereafter, a reason for this, and a more detailed configuration, will be described.

As previously described, when the inverter circuit 20 is separated from the direct current power supply 90 due to the power switch 70 being opened while the electric motor 10 is carrying out a regenerative operation, or due to a power line between the direct current power supply 90 and the inverter circuit 20 being disconnected, the direct current power supply 90 cannot be charged with regenerative power flowing into the inverter circuit 20 from the electric motor 10, the capacitor 22 of the inverter circuit 20 is charged, and a problem may occur in that the capacitor 22 is damaged due to an overvoltage being applied to the capacitor 22.

Because of this, there is a method whereby the six-switch opening process, which causes an inverter operation to stop, is executed as a countermeasure. When this six-switch opening process is executed, however, power accumulated in a stator coil of the electric motor charges the capacitor via a freewheeling diode (FWD) connected in inverse parallel to the switching element, and there are cases wherein an inter-terminal voltage of the capacitor rises steeply.

There is a tendency for this rise in the inter-terminal voltage of the capacitor to become greater the greater the rotational speed of the electric motor becomes. As an induced voltage of the electric motor has a proportional relationship with the rotational speed, the greater the rotational speed of the electric motor becomes, the further the induced voltage of the electric motor increases, because of which a supply of regenerative energy to the capacitor caused by the induced voltage increases, and the rise in the inter-terminal voltage of the capacitor becomes greater.

Meanwhile, as another method, there is a method such that the three-phase short-circuiting process whereby all the upper side switching elements or all the lower side switching elements of the inverter circuit are turned on, causing the phases of the electric motor to short-circuit each other, is executed, because of which regenerative power is prevented from accumulating in the capacitor. When the three-phase short-circuiting process is executed, however, the phases of the electric motor reach a state of being connected to each other across small resistance, because of which a phase current flowing through each phase momentarily increases. This phase current that has momentarily increased flows in a direction that causes demagnetization of the permanent magnet included in the electric motor.

Generally, a rare-earth magnet often used as a permanent magnet of an electric motor is characterized by having a large energy product, but it is well-known that when used in a region exceeding a knick point, irreversible demagnetization occurs, and the properties decline. A permanent magnet is demagnetized due to an excitation coil being energized with a large current, and a large demagnetizing field being applied to the magnet, because of which the current is normally controlled in such a way that a demagnetizing direction magnetic flux applied to a permanent magnet does not exceed a predetermined value.

When the three-phase short-circuiting process is executed, however, all the upper side switching elements or all the lower side switching elements are turned on, whereby the phases of the electric motor are caused to short-circuit each other, because of which it is difficult to control current in such a way that a demagnetizing direction magnetic flux does not exceed a predetermined value. This means that when the three-phase short-circuiting process is executed, irreversible demagnetization occurs when a demagnetizing field applied to the permanent magnet that occurs due to a flowing momentary large current exceeds a magnetic field of the permanent magnet that generates an irreversible demagnetization.

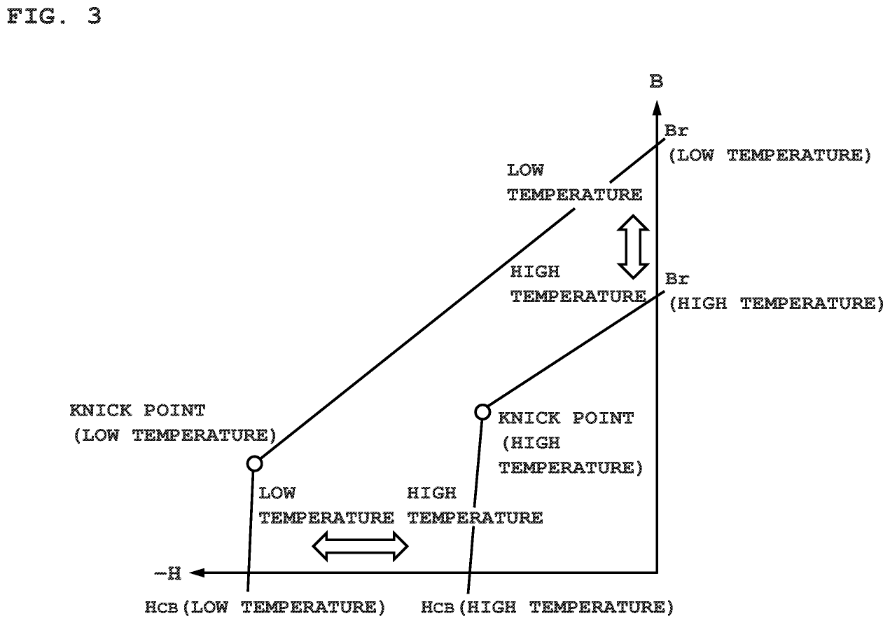

FIG. 3 shows one example of magnetic properties of a rare-earth magnet often used as a permanent magnet of an electric motor. Generally, the higher the temperature of a permanent magnet becomes, the farther the knick point moves to a low magnetic field side. In other words, it can be said that the higher the temperature of a permanent magnet becomes, the more likely irreversible demagnetization is to occur, and irreversible demagnetization occurs even with the smaller phase current. Conversely, the lower the temperature becomes, the farther the knick point moves to a high magnetic field side, the less likely irreversible demagnetization is to occur, and irreversible demagnetization no longer occurs even at a greater phase current. Herein, a side wherein an absolute value is small is defined as a low magnetic field, and conversely, a side wherein a value is large in a negative direction is defined as a high magnetic field.

Also, the higher the temperature of a permanent magnet becomes, the farther a residual magnetic flux density Br decreases, and the lower the temperature becomes, the farther the residual magnetic flux density Br increases. In other words, the higher the temperature of a permanent magnet becomes, the farther an induced voltage decreases, and the lower the temperature of a permanent magnet becomes, the farther an induced voltage rises.

That is, when the magnet temperature is high, a rise in the inter-terminal voltage of the capacitor is small when the six-switch opening process is executed, but when the three-phase short-circuiting process is executed, irreversible demagnetization is likely to occur. Meanwhile, when the magnet temperature is low, a rise in the inter-terminal voltage of the capacitor is large when the six-switch opening process is executed, but when the three-phase short-circuiting process is executed, irreversible demagnetization is unlikely to occur.

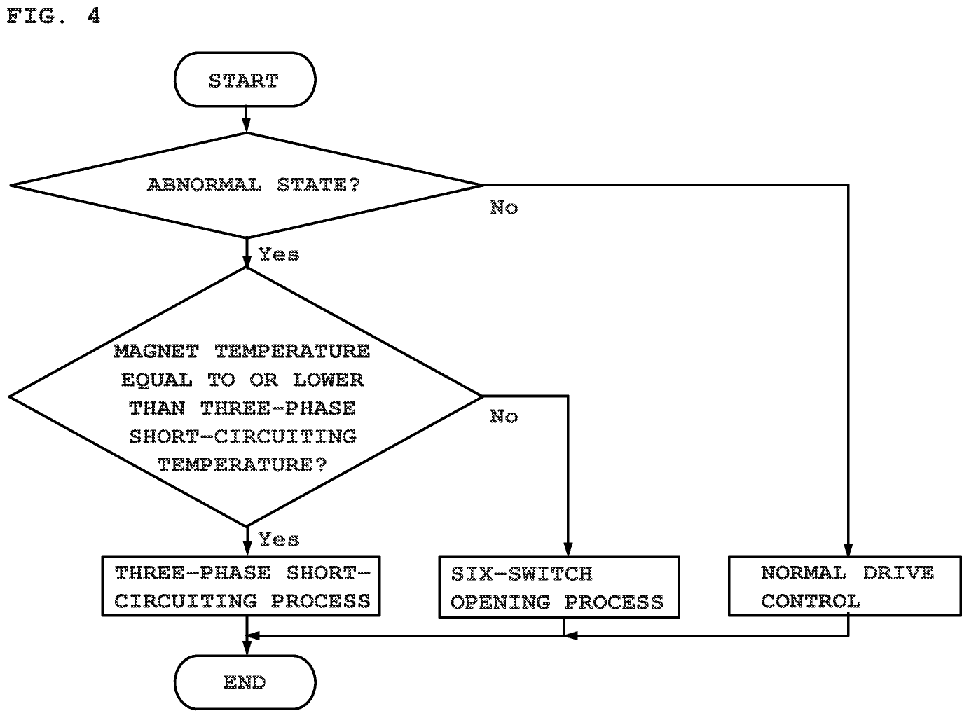

Next, an operation of the electric motor control device 1 according to the first embodiment will be described, with reference to a flowchart shown in FIG. 4.

Firstly, the abnormality determining circuit 42, based on a direct current bus voltage input from the voltage detector 23, determines whether or not an abnormal state of the power supply side is an abnormal state of the power supply side such that the direct current power supply 90 cannot be charged with regenerative power. Specifically, the abnormality determining circuit 42 determines that the power supply side is an abnormal state, and that the direct current power supply 90 cannot be charged with regenerative power, when the direct current bus voltage is equal to or greater than a setting value specified in advance, and determines that the power supply side is in a normal state in any other case.

This means that when regenerative power is accumulated in the capacitor 22 due to the electric motor 10 carrying out a regenerative operation, and the voltage across the capacitor 22, that is, the direct current bus voltage, reaches a high voltage state that does not occur during a normal operation, when the power switch 70 is in an opened state, or when the direct current power supply 90 cannot be charged with regenerative power when the direct current power supply 90 reaches a high voltage state that does not occur during a normal operation, even when the power switch 70 is in a conductive state, the abnormality determining circuit 42 can determine that the power supply side is in an abnormal state.

When it is determined by the abnormality determining circuit 42 that the power supply side is in a normal state, there is no problem, the electric motor 10 is in a state of being able to carry out a powering operation or a regenerative operation, and no abnormality countermeasure command is output from the abnormality countermeasure selecting circuit 43 to the switching control signal generating circuit 41. Consequently, the switching control signal generating circuit 41 executes a normal inverter circuit drive control when no abnormality countermeasure command is input from the abnormality countermeasure selecting circuit 43.

Expressed simply, a target torque or a target current of the electric motor 10 is input into another control device, such as an unshown the vehicle ECU, via a controller area network (CAN), and the control device executes current feedback control using the direct current bus voltage information input from the voltage detector 23, the rotation angle information of the electric motor 10 input from the rotation angle sensor 60, and the electric motor current information input from the current detecting circuit 24, computes an on/off control signal for each of the switching elements 31 to 36 of the power conversion circuit 30 in order that the target torque or the target current of the electric motor 10 is obtained, and outputs the on/off control signals to the power conversion circuit 30. As current feedback control is publicly known, a detailed description will be omitted here.

Information relating to the temperature of the permanent magnet of the electric motor 10 from the temperature sensor 50, and a power supply side abnormality state determination result from the abnormality determining circuit 42, are input into the abnormality countermeasure selecting circuit 43, and when it is determined, based on these items of input information, that the power supply side is in an abnormal state, the abnormality countermeasure selecting circuit 43 selects either the three-phase short-circuiting process or the six-switch opening process, and outputs the selection to the switching control signal generating circuit 41 as the abnormality countermeasure command.

More specifically, when it is determined that the power supply side is in an abnormal state, the abnormality countermeasure selecting circuit 43 selects the six-switch opening process when the temperature of the permanent magnet of the electric motor 10 is higher than a three-phase short-circuiting process execution temperature, selects the three-phase short-circuiting process when the temperature of the permanent magnet of the electric motor 10 is lower than the three-phase short-circuiting process execution temperature, and generates and outputs the abnormality countermeasure command.

Herein, the three-phase short-circuiting process execution temperature is set to be an upper limit value of the temperature of the permanent magnet wherein a demagnetizing field applied to the permanent magnet generated in accordance with a maximum value of an increasing phase current does not exceed the knick point of the permanent magnet when the three-phase short-circuiting process is executed. Also, when the six-switch opening process is executed at the three-phase short-circuiting process execution temperature, the capacitor is selected in such a way that a maximum value of a rising inter-terminal voltage of the capacitor 22 is smaller than an overvoltage threshold. The overvoltage threshold is set to be a voltage value that does not exceed a withstand voltage of a composite component of the capacitor or the inverter circuit, as is generally set by the electric motor control device.

When the three-phase short-circuiting process is input as the abnormality countermeasure command from the abnormality countermeasure selecting circuit 43, the switching control signal generating circuit 41 outputs on/off control signals to the power conversion circuit 30 in order that the upper side switching elements 31, 33, and 35 are turned on, and the lower side switching elements 32, 34, and 36 are turned off. Alternatively, when the three-phase short-circuiting process is input as the abnormality countermeasure command from the abnormality countermeasure selecting circuit 43, the switching control signal generating circuit 41 outputs on/off control signals to the power conversion circuit 30 in order that the upper side switching elements 31, 33, and 35 are turned off, and the lower side switching elements 32, 34, and 36 are turned on.

Also, when the six-switch opening process is input as the abnormality countermeasure command from the abnormality countermeasure selecting circuit 43, the switching control signal generating circuit 41 outputs on/off control signals to the power conversion circuit 30 in order that all the switching elements 31 to 36 are turned off.

Due to adopting this kind of configuration, it is determined by the abnormality determining circuit 42 whether or not there is a state wherein the direct current power supply 90 cannot be charged with regenerative power based on the voltage of the direct current buses 21a and 21b, and when there is a state wherein the direct current power supply 90 cannot be charged with regenerative power, an abnormality countermeasure can be carried out appropriately in accordance with the temperature of the permanent magnet of the electric motor 10, because of which both of restricting a rise in the inter-terminal voltage of the capacitor 22 and restricting an occurrence of an irreversible demagnetization accompanying a rise in the phase current of the electric motor 10 can be achieved.

Specifically, in a case in which the permanent magnet temperature is high, wherein permanent magnet demagnetization tolerance is low and there is a possibility of an irreversible demagnetization of the permanent magnet of the electric motor occurring when the three-phase short-circuiting process is executed, the occurrence of an irreversible demagnetization of the permanent magnet of the electric motor occurring due to a rise in a phase current when the three-phase short-circuiting process is executed can be restricted by executing the six-switch opening process.

Also, in a case in which a flow of regenerative energy into the capacitor is high and the permanent magnet temperature is low when the six-switch opening process is executed, an occurrence of a problem in a composite component of the capacitor or the inverter circuit occurring due to a rise in the inter-terminal voltage of the capacitor when the six-switch opening process is executed can be restricted by executing the three-phase short-circuiting process.

In other words, an operating state of the electric motor in which the six-switch opening process is executed is limited to a case in which the flow of regenerative energy into the capacitor is comparatively small and the permanent magnet temperature is high, meaning that a small capacity that can tolerate a comparatively small regenerative energy inflow is sufficient as a capacitor capacity, as a result of which a capacitor size can be small.

Also, an operating state of the electric motor in which the three-phase short-circuiting process is executed is limited to a case in which an irreversible demagnetization of the permanent magnet is unlikely to occur and the permanent magnet temperature is low, meaning that the demagnetization tolerance of the permanent magnet of the electric motor may be comparatively low, as a result of which an electric motor size can be small.

Generally, in order to prevent irreversible demagnetization, there is a method whereby a thickness in a permanent magnet magnetization direction is increased. Also, there is a method whereby a permanent magnet coercive force is increased, but as a permanent magnet coercive force and a residual magnetic flux density are in a trade-off relationship, the residual magnetic flux density decreases when the coercive force is increased in order to prevent irreversible demagnetization. As a result of this, electric motor output torque decreases, meaning that it is necessary to increase a magnet amount or increase the size of the electric motor in order to obtain equivalent output properties, which is an impediment to reducing the size and reducing the cost of the electric motor. In response to this, the present application prevents irreversible demagnetization without increasing the permanent magnet coercive force.

In this way, the electric motor control device according to the first embodiment is such that when the direct current power supply cannot be charged with regenerative power, the six-switch opening process is executed in a case in which the permanent magnet temperature is high, wherein there is a possibility of an irreversible demagnetization of the permanent magnet occurring when the three-phase short-circuiting process is executed, and the three-phase short-circuiting process is executed when a flow of regenerative energy into the capacitor is high and the permanent magnet temperature is low when the six-switch opening process is executed, whereby both of restricting a rise in the inter-terminal voltage of the capacitor and restricting an occurrence of an irreversible demagnetization of the permanent magnet of the electric motor can be achieved, without adding a new circuit, and there is an advantage in that an electric motor control device such that no failure is caused to occur in the inverter circuit even when the inverter circuit and the direct current power supply are separated during a regenerative operation can be realized in a small size and at a low cost.

In the description of the first embodiment, a configuration is such that the three-phase short-circuiting process execution temperature is set to be the upper limit value of the temperature of the permanent magnet wherein a demagnetizing field applied to the permanent magnet generated in accordance with the maximum value of the increasing phase current does not exceed the knick point of the permanent magnet when the three-phase short-circuiting process is executed, but provided that the three-phase short-circuiting process execution temperature is a permanent magnet temperature such that the maximum value of the inter-terminal voltage of the capacitor, which rises when the six-switch opening process is executed, is smaller than the overvoltage threshold, there is no problem in the three-phase short-circuiting process execution temperature being set to be a permanent magnet temperature smaller than the aforementioned upper limit value.

Also, in the description of the first embodiment, a configuration is such that the abnormality determining circuit 42 of the switching control circuit 40 determines whether or not the power supply side is in an abnormal state based on voltage information relating to the direct current buses 21a and 21b input from the voltage detector 23, but as another configuration, for example, the matter that the power switch 70 is in an opened state is conveyed from an unshown vehicle ECU or an external control device, and the abnormality determining circuit 42 may determine that the power supply side is in an abnormal state when the power switch 70 is in an opened state.

### Second Embodiment

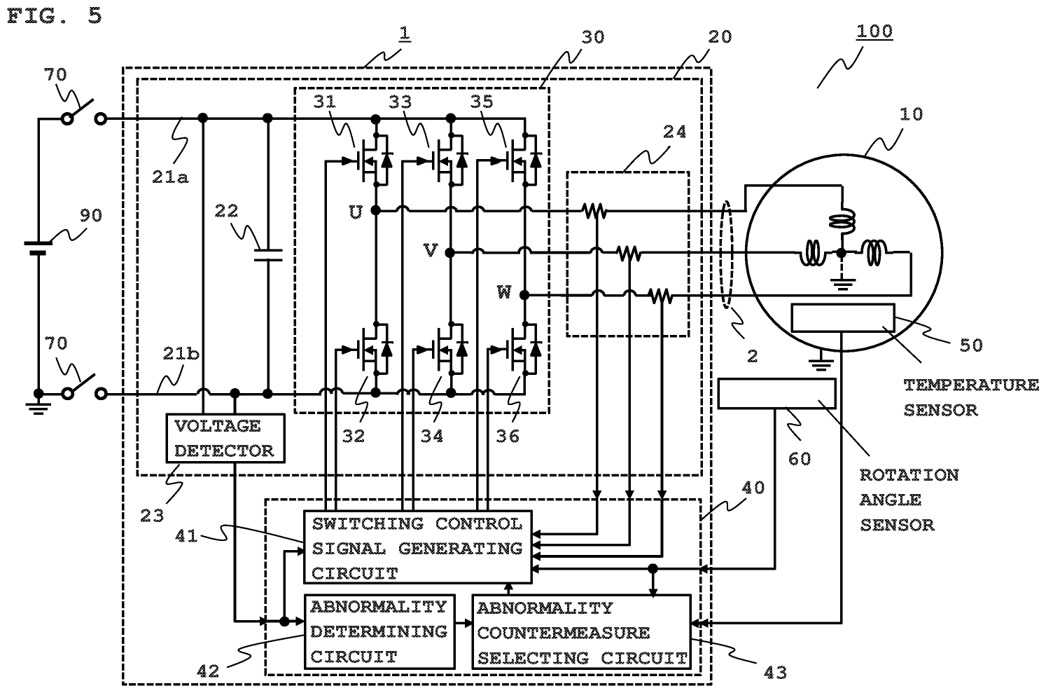

FIG. 5 is a block drawing showing a configuration of the electric motor drive system 100 in which the electric motor control device 1 according to a second embodiment is mounted. A difference from the first embodiment is that the electric motor control device 1 of the first embodiment is such that a determination of whether or not there is a state wherein the direct current power supply 90 can be charged with regenerative power is carried out based on the direct current bus voltage, and when there is a state wherein the direct current power supply 90 cannot be charged with regenerative power, the abnormality countermeasure selecting circuit 43 selects an abnormality countermeasure from the six-switch opening process and the three-phase short-circuiting process based on the temperature of the permanent magnet of the electric motor 10, whereas the electric motor control device 1 of the second embodiment is such that the abnormality countermeasure selecting circuit 43 selects an abnormality countermeasure from the six-switch opening process and the three-phase short-circuiting process based on the temperature of the permanent magnet of the electric motor 10 and the rotation angle of the rotor. As other configurations are the same as in the first embodiment, a description will be omitted.

Next, an operation of the electric motor control device 1 according to the second embodiment will be described in detail, based on FIGS. 5 to 7, focusing on the difference from the first embodiment.

FIG. 5 includes an illustration of a battery that is, for example, the direct current power source 90, which supplies direct current power to the inverter circuit 20 and is charged by regenerative power, and a three-phase synchronous electric motor that is the electric motor 10, which is a control target. In FIG. 5, the electric motor control device 1 is configured of the inverter circuit 20 and the switching control circuit 40, in the same way as in the first embodiment, but the rotation angle of the rotor of the electric motor 10 detected by the rotation angle sensor 60 is added to a signal input into the abnormality countermeasure selecting circuit 43 of the switching control circuit 40.

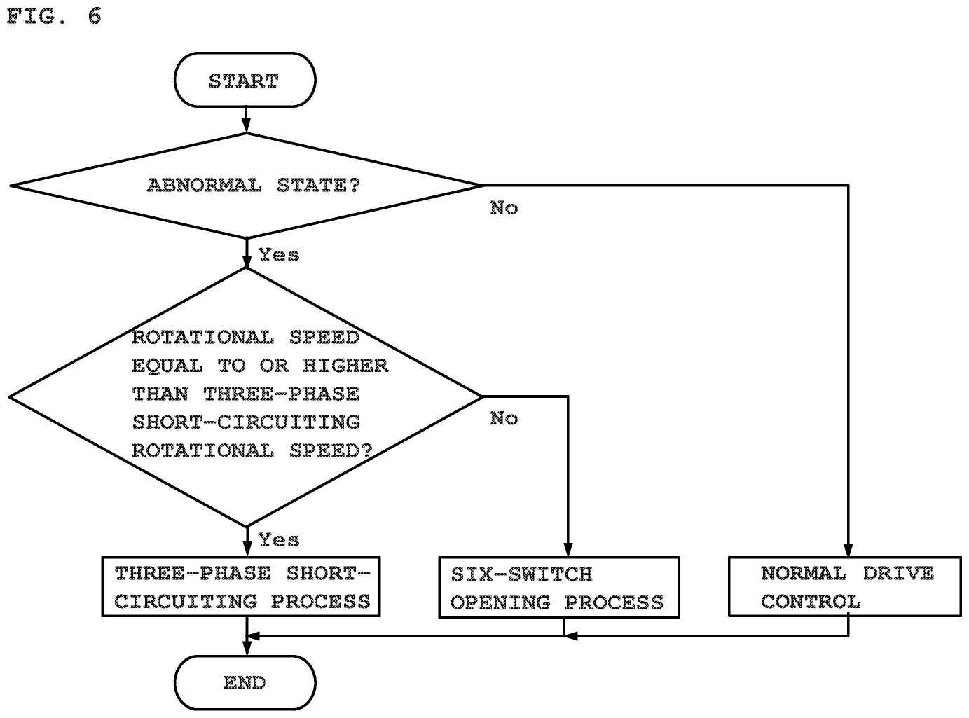

Hereafter, an operation of the electric motor control device 1 in the second embodiment will be described while referring to an operational flowchart of the electric motor control device 1 shown in FIG. 6.

Herein, a portion wherein the abnormality determining circuit 42 determines whether or not the power supply side is in an abnormal state such that the direct current power supply 90 cannot be charged with regenerative power from the electric motor 10 based on direct current bus voltage input from the voltage detector 23 is the same as in the first embodiment.

Also, a portion wherein, when it is determined by the abnormality determining circuit 42 that the power supply side is in an abnormal state, the abnormality countermeasure selecting circuit 43 selects either the three-phase short-circuiting process or the six-switch opening process using a method to be described hereafter, and outputs the selection to the switching control signal generating circuit 41 as an abnormality countermeasure command, is the same as in the first embodiment, but the method whereby the abnormality countermeasure selecting circuit 43 selects the three-phase short-circuiting process or the six-switch opening process differs from that of the first embodiment.

A characteristic of the electric motor control device 1 according to the second embodiment is that the abnormality countermeasure selecting circuit 43 is provided in the switching control circuit 40, and when it is determined that the power supply side is in an abnormal state, the abnormality countermeasure selecting circuit 43 selects whether to execute the three-phase short-circuiting process or to execute the six-switch opening process based on rotation angle information and magnet temperature information relating to the electric motor 10. According to this configuration, both of restricting a rise in the inter-terminal voltage of the capacitor 22 and restricting an occurrence of an irreversible demagnetization accompanying a rise in the phase current of the electric motor 10 can be achieved, even when the inverter circuit 20 is separated from the direct current power supply 90.

Hereafter, a reason that both of restricting a rise in the inter-terminal voltage of the capacitor 22 and restricting an occurrence of an irreversible demagnetization accompanying a rise in the phase current of the electric motor 10 can be achieved according to the configuration of the second embodiment will be described in more detail.

When it is determined that the power supply side is in an abnormal state, the abnormality countermeasure selecting circuit 43 selects the six-switch opening process when the rotational speed of the electric motor 10 computed using the rotation angle information is less than a three-phase short-circuiting execution rotational speed set based on the permanent magnet temperature, and selects the three-phase short-circuiting process when the rotational speed of the electric motor 10 is greater than the three-phase short-circuiting execution rotational speed.

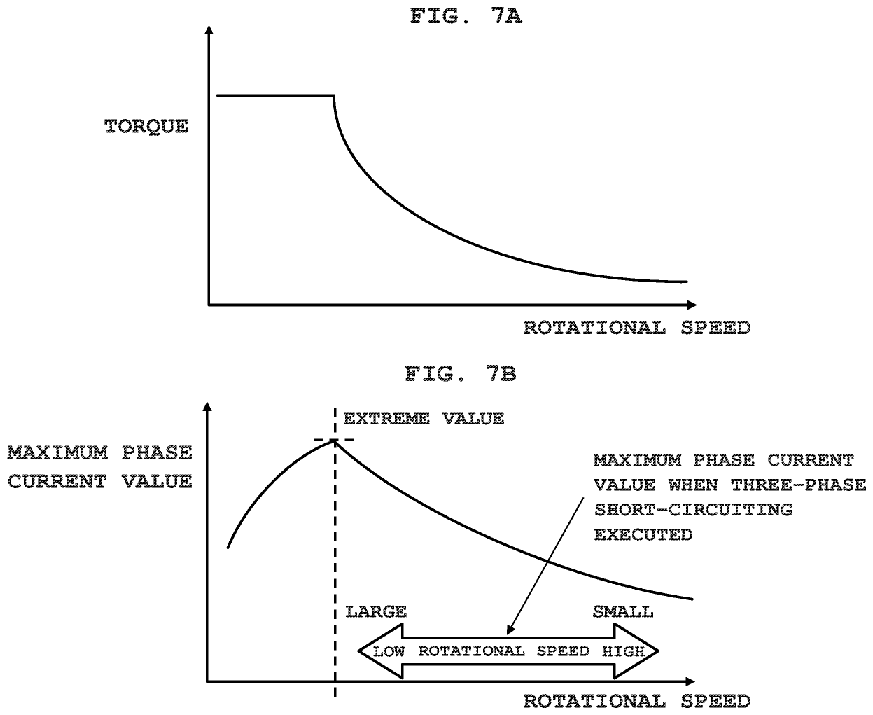

FIGS. 7A and 7B show one example of a drive pattern at a time of a maximum load of an electric motor revealed by FEM analysis (FIG. 7A), and a maximum value of a phase current, which rises transiently when the three-phase short-circuiting process is executed, at various corresponding rotational speeds (FIG. 7B). From the drawing, it can be seen that the maximum phase current value after the three-phase short-circuiting process is executed increases in accompaniment to an increase in the rotational speed when the rotational speed is low, but after once passing through an extreme value, becomes lower the higher the rotational speed becomes, and becomes higher the lower the rotational speed becomes.

Consequently, when the rotational speed of the electric motor 10 is high, the rise in the inter-terminal voltage of the capacitor 22 is greater when the six-switch opening process is executed, but when the three-phase short-circuiting process is executed, the maximum phase current value decreases. Meanwhile, when the rotational speed of the electric motor 10 is low among rotational speeds equal to or greater than that at which the maximum phase current value is the extreme value when the three-phase short-circuiting process is executed, the rise in the inter-terminal voltage of the capacitor 22 is smaller when the six-switch opening process is executed, but when the three-phase short-circuiting process is executed, the maximum phase current value increases.

Therefore, when it is determined that the power supply side is in an abnormal state, the abnormality countermeasure selecting circuit 43 selects the six-switch opening process when the rotational speed of the electric motor 10 computed using the rotation angle information is less than the three-phase short-circuiting execution rotational speed set based on the permanent magnet temperature, and selects the three-phase short-circuiting process when the rotational speed of the electric motor 10 is greater than the three-phase short-circuiting execution rotational speed, as previously described.

Therefore, when the three-phase short-circuiting process is executed, the three-phase short-circuiting execution rotational speed is set to be a rotational speed equal to or greater than that at which the maximum phase current value is the extreme value, and a lower limit of a rotational speed at which a demagnetizing field generated at the maximum value of the increasing phase current does not increase with respect to a magnetic field which generates irreversible demagnetization, determined in accordance with the knick point, which changes in accordance with the permanent magnet temperature.

That is, in a state wherein the permanent magnet demagnetization tolerance is low, and there is a possibility of an irreversible demagnetization of the permanent magnet occurring, but the inflow of regenerative energy to the capacitor is small when the six-switch opening process is executed, that is, in a state wherein the permanent magnet temperature is high, the three-phase short-circuiting execution rotational speed is set to a high rotational speed side. When the permanent magnet demagnetization tolerance is high, and there is little possibility of an irreversible demagnetization of the permanent magnet occurring, but the inflow of regenerative energy to the capacitor is high and the permanent magnet temperature is low when the six-switch opening process is executed, the three-phase short-circuiting execution rotational speed is set to a low rotational speed side.

Adopting this kind of configuration means that the six-switch opening process is executed in an electric motor operating state wherein the rotational speed at which there is a possibility of an irreversible demagnetization of the permanent magnet occurring is low, and the permanent magnet temperature is high, because the maximum phase current value is high, and furthermore, the permanent magnet demagnetization tolerance is low, when the three-phase short-circuiting process is executed, whereby an occurrence of an irreversible demagnetization of the permanent magnet of the electric motor occurring due to a rise in the phase current in accompaniment to an execution of the three-phase short-circuiting process can be restricted. Also, the three-phase short-circuiting process is executed in an electric motor operating state wherein the inflow of regenerative energy to the capacitor is in a high state, that is, the rotational speed is high, and the permanent magnet temperature is low when the six-switch opening process is executed, whereby an occurrence of a failure in the capacitor or a constituent component of the inverter circuit occurring due to a rise in the inter-terminal voltage of the capacitor in accompaniment to an execution of the six-switch opening process can be restricted.

In other words, an electric motor operating state in which the six-switch opening process is executed is limited to an electric motor operating state wherein the inflow of regenerative energy to the capacitor is small, that is, the rotational speed is low, and the permanent magnet temperature is high, meaning that a small capacity that can tolerate a comparatively small regenerative energy inflow is sufficient as a capacitor capacity, as a result of which the capacitor size can be reduced. Also, an electric motor operating state in which the three-phase short-circuiting process is executed is limited to a case wherein irreversible demagnetization of the permanent magnet is unlikely to occur, the maximum phase current value is low, the rotational speed is high, and the temperature of the permanent magnet of the electric motor is low, meaning that the demagnetization tolerance of the permanent magnet of the electric motor can be comparatively low, as a result of which the electric motor size can be reduced.

In this way, the electric motor control device according to the second embodiment is such that when the direct current power supply cannot be charged with regenerative power, the six-switch opening process is executed in a case in which the temperature of the permanent magnet wherein there is a possibility of an irreversible demagnetization of the permanent magnet occurring when the three-phase short-circuiting process is executed is high, and the rotational speed is low, and the three-phase short-circuiting process is executed when the flow of regenerative energy into the capacitor is high, that is, the permanent magnet temperature is low, and the rotational speed is high when the six-switch opening process is executed, whereby both of restricting a rise in the inter-terminal voltage of the capacitor and restricting an occurrence of an irreversible demagnetization of the permanent magnet of the electric motor can be achieved, without adding a new circuit, and there is an advantage in that an electric motor control device such that no failure is caused to occur even when the inverter circuit and the direct current power supply are separated during a regenerative operation can be realized in a small size and at a low cost.

In the description of the second embodiment, a configuration is such that when the three-phase short-circuiting process is executed, the three-phase short-circuiting execution rotational speed is set to be a rotational speed equal to or greater than that at which the maximum phase current value is the extreme value, and a lower limit value of a rotational speed at which a demagnetizing field generated at the maximum value of the phase current, which increases when the three-phase short-circuiting process is executed, does not increase with respect to a magnetic field which generates irreversible demagnetization, determined in accordance with the knick point, which changes in accordance with the permanent magnet temperature, but provided that the three-phase short-circuiting execution rotational speed is a rotational speed in accordance with a magnet temperature such that the maximum value of the inter-terminal voltage of the capacitor, which rises when the six-switch opening process is executed at the three-phase short-circuiting execution rotational speed, is smaller than the overvoltage threshold, there is no problem in the three-phase short-circuiting execution rotational speed being set to be a rotational speed greater than the aforementioned lower limit value.

With regard to the magnet temperature of the electric motor 10 acquired using the temperature sensor 50 in the first and second embodiments, it is desirable that the temperature of the permanent magnet that reaches the highest temperature among a multiple of permanent magnets included in the electric motor 10 is acquired. In general, the higher the magnet temperature, the lower the demagnetization tolerance, meaning that irreversible demagnetization can be reliably restricted by the temperature of a portion of the magnet that reaches the highest temperature being acquired using the temperature sensor.

A type of semiconductor of the switching elements 31 to 36 applied to the power conversion circuit 30 is not particularly limited but, for example, a wide-bandgap semiconductor can be used. For example, a semiconductor element formed of silicon carbide (SiC), a gallium nitride (GaN) based material, or a diamond (C) can be used as a wide bandgap semiconductor element.

Compared with an existing inverter circuit configured of switching elements formed of silicon (Si), an inverter circuit configured of switching elements formed of this kind of wide bandgap semiconductor is characterized in that a withstand voltage is high, loss is low, and a high frequency drive can be carried out. Hereafter, an inverter circuit configured of switching elements formed of a wide bandgap semiconductor will be called a wide bandgap inverter circuit, and an inverter circuit configured of switching elements formed of silicon (Si) will be called a silicon inverter circuit.

This means that compared with an electric motor control device in which a silicon inverter circuit is used, an electric motor control device in which a wide bandgap inverter circuit is used is such that the switching element has a high withstand voltage, because of which voltage restriction by the switching element with respect to a capacitor inter-terminal voltage upper limit is relaxed, and a rise in the capacitor inter-terminal voltage when the six-switch opening process is executed is comparatively tolerated. That is, when the six-switch opening process is executed at the three-phase short-circuiting execution temperature, the maximum tolerable value of the rising capacitor inter-terminal voltage can be comparatively high.

Furthermore, compared with an electric motor control device in which a silicon inverter circuit is used, an electric motor control device in which a wide bandgap inverter circuit is used is such that a high frequency drive can be carried out, because of which an amplitude of a high frequency magnetic flux, which is a factor in a generation of an eddy current occurring in the permanent magnet of the electric motor, can be reduced. Because of this, the permanent magnet temperature when the electric motor is driven can be reduced, meaning that the three-phase short-circuiting execution rotational speed can be set farther to the low speed side. Because of this, the six-switch opening process is executed only at a lower rotational speed, and a tolerable range of a rise in the capacitor inter-terminal voltage can be widened, because of which the capacitor capacity can be reduced, and the capacitor size can be reduced.

The first and second embodiments show only examples, and provided that the present application can be applied, the present application is in no way limited to the heretofore described embodiments. For example, in the first and second embodiments, a case wherein the direct current power supply 90 and the electric motor control device 1 are directly connected has been described, but a configuration wherein a DC/DC converter that carries out a stepping-up or a stepping-down is disposed between the direct current power supply 90 and the electric motor control device 1 may be adopted, or a configuration wherein the electric motor control device 1 is connected to an alternating current power supply via a rectifier or an AC/DC converter, which converts alternating current power of an alternating current power supply into direct current power, may be adopted.

Also, in the first and second embodiments, characteristics and operations as an electric motor control device have been described, but the present application may also be applied to the electric motor drive system 100 that includes the electric motor control device 1 and the electric motor 10, in which case advantages of reducing the size of the electric motor control device 1 and reducing the size of the electric motor 10 can be acquired simultaneously.

Also, in the first and second embodiments, the three-phase short-circuiting process is selected as a countermeasure against an abnormality wherein the capacitor 22 is not charged with regenerative power, but instead of this, a configuration wherein two of the upper side switching elements 31, 33, and 35 or two of the lower side switching elements 32, 34, and 36 are turned on simultaneously in accordance with a drive situation of the electric motor 10 may be adopted. Also, in the first and second embodiments, a three-phase synchronous electric motor is adopted as the electric motor 10, but a case may be such that an electric motor of two phases, or four or more phases, is adopted as a target.

Also, in the first and second embodiments, an abnormal state of the power supply side wherein the direct current power supply 90 cannot be charged with regenerative power has been described as an example of an abnormality of the electric motor control device 1, but not being limited to this, a case may be such that the present application is applied when, for example, there is an overheating abnormality of the electric motor control device 1.

Also, in the first and second embodiments, the temperature of the permanent magnet of the electric motor 10 is acquired using the temperature sensor 50, but not being limited to this, for example, a temperature other than that of the permanent magnet may be acquired, and the temperature of the permanent magnet may be computed from a value thereof, an estimated magnet temperature value in accordance with a drive state of the electric motor 10 may be used in advance, or the permanent magnet temperature may be estimated from information relating to an inter-phase voltage of the electric motor 10.

Also, in the first and second embodiments, an electric vehicle has been described as an example, but the present application may be applied to a hybrid vehicle in which both an engine and an electric motor are used, and furthermore, applications are not limited to a vehicle.

Although the present application is described above in terms of various exemplifying embodiments and implementations, it should be understood that the various features, aspects, and functionality described in one or more of the individual embodiments are not limited in their applicability to the particular embodiment with which they are described, but instead can be applied, alone or in various combinations, to one or more other embodiments.

It is therefore understood that numerous modifications which have not been exemplified can be devised without departing from the scope of the present application. For example, at least one of the constituent components may be modified, added, or eliminated. At least one of the constituent components mentioned in at least one of the preferred embodiments may be selected and combined with the constituent components mentioned in another preferred embodiment.

What is claimed is:

1. An electric motor control device, comprising:
an inverter circuit that has a power conversion circuit that supplies alternating current drive power to an electric motor having permanent magnets, and in which three phases of arms are each configured of a series circuit of an upper side switching element and a lower side switching element; and
a switching control circuit that controls the switching elements of the power conversion circuit in such a way as to be turned on or off, wherein
the switching control circuit has an abnormality determining circuit that determines whether or not the inverter circuit or a power supply side of the inverter circuit is in an abnormal state, and
an abnormality countermeasure selecting circuit that, when it is determined by the abnormality determining circuit that there is an abnormal state, selects whether to execute a three-phase short-circuiting process, whereby all the upper side switching elements or all the lower side switching elements are turned on, or a six-switch opening process, whereby all the switching elements of the power conversion circuit are turned off, in accordance with an operating state of the electric motor, and
the abnormality countermeasure selecting circuit acquires a temperature of at least one of the permanent magnets of the electric motor, and selects which of the three-phase short-circuiting process or the six-switch opening process to execute based on the temperature of the permanent magnet.

2. The electric motor control device according to claim 1, wherein the abnormality determining circuit determines whether or not there is an abnormal state wherein a direct current power supply that supplies power to the inverter circuit cannot be charged with regenerative power from the electric motor.

3. The electric motor control device according to claim 2, wherein the abnormality determining circuit determines that there is an abnormal state when a direct current bus voltage of the power conversion circuit becomes equal to or greater than a predetermined setting value.

4. The electric motor control device according to claim 1, wherein the abnormality countermeasure selecting circuit selects the six-switch opening process when the temperature of the permanent magnet is higher than a three-phase short-circuiting execution temperature, and selects the three-phase short-circuiting process when the temperature of the permanent magnet is lower than the three-phase short-circuiting execution temperature.

5. The electric motor control device according to claim 4, wherein the three-phase short-circuiting execution temperature is set to be the temperature of the permanent magnet such that a maximum value of a transient phase current of the electric motor generated when the three-phase short-circuiting process is executed is smaller than a current such that irreversible demagnetization occurs.

6. The electric motor control device according to claim 5, wherein the three-phase short-circuiting execution temperature is set to be an upper limit value of the temperature of the permanent magnet such that the maximum value of a transient phase current of the electric motor generated when the three-phase short-circuiting process is executed is smaller than the current such that irreversible demagnetization occurs.

7. The electric motor control device according to claim 1, wherein the abnormality countermeasure selecting circuit acquires a rotational speed of the electric motor using a rotation angle sensor attached to the electric motor, and selects which of the three-phase short-circuiting process or the six-switch opening process to execute based on the temperature of the permanent magnet and the rotational speed.

8. The electric motor control device according to claim 7, wherein the abnormality countermeasure selecting circuit selects the six-switch opening process when the rotational speed is lower than a three-phase short-circuiting execution rotational speed, and selects the three-phase short-circuiting process when the rotational speed is higher than the three-phase short-circuiting execution rotational speed, and furthermore, the three-phase short-circuiting execution rotational speed is set in accordance with the temperature of the permanent magnet.

9. The electric motor control device according to claim 8, wherein the three-phase short-circuiting execution rotational speed is set to a high rotational speed side in accompaniment to a rise in the temperature of the permanent magnet, and set to a low rotational speed side in accompaniment to a drop in the temperature of the permanent magnet.

10. The electric motor control device according to claim 9, wherein the three-phase short-circuiting execution rotational speed is set to be a rotational speed such that the maximum value of a transient phase current of the electric motor generated when the three-phase short-circuiting process is executed does not exceed a phase current corresponding to the temperature of the permanent magnet such that irreversible demagnetization occurs.

11. The electric motor control device according to claim 9, wherein the three-phase short-circuiting execution rotational speed is set to be a lower limit of a rotational speed that is equal to or greater than a predetermined rotational speed, and is such that the maximum value of a transient phase current of the electric motor generated when the three-phase short-circuiting process is executed does not exceed a phase current corresponding to the temperature of the permanent magnet such that irreversible demagnetization occurs.

12. The electric motor control device according to claim 11, wherein the predetermined rotational speed is set to be a rotational speed such that when the electric motor is driven at a maximum load, the maximum value of a transient phase current of the electric motor generated when the three-phase short-circuiting process is executed is an extreme value.

13. The electric motor control device according to claim 1, wherein the temperature of the permanent magnet is such that the temperature of a portion in which the temperature is highest is acquired.

14. The electric motor control device according to claim 1, wherein the switching elements configuring the power conversion circuit are formed of wide bandgap semiconductors.

15. An electric motor drive system, comprising:
the electric motor; and
the electric motor control device according to claim 1.
